(19) United States
(12) Patent Application Publication
(10) Pub. No.: US 2026/0022066 A1
(43) Pub. Date: Jan. 22, 2026

(54) LIGHT WEIGHT AGGREGATE FOR LOW CARBON LIGHT WEIGHT CONCRETE

(71) Applicants: Solid Carbon, Inc., McMinnville, OR (US); Colorado School Of Mines, Golden, CO (US)

(72) Inventors: Johnathan Douglas Mead, McMinnville, OR (US); Allan Mackenzie Whitaker, IV, Sheridan, OR (US); Lori Tunstall, Golden, CO (US)

(21) Appl. No.: 19/274,267

(22) Filed: Jul. 18, 2025

Related U.S. Application Data
(60) Provisional application No. 63/673,530, filed on Jul. 19, 2024.

(51) Int. Cl. C04B 18/02; C04B 18/26; C04B 18/30; C04B 20/02; C04B 111/40

(52) U.S. Cl. CPC C04B 18/027; C04B 18/021; C04B 18/26; C04B 18/305; C04B 20/0232; C04B 2111/40

(57) ABSTRACT

Systems and method are provided for a low carbon light weight aggregate made from disk pelletizing biochar; binder; supplementary cementitious material (SCM); fine aggregates; and water.

### CROSS-REFERENCE TO RELATED APPLICATIONS

The present application claims priority of U.S. Provisional Application No. 63/673,530 entitled “LOW CARBON CONCRETE AGGREGATE”, and filed on Jul. 19, 2024. The entire contents of the above-listed application are hereby incorporated by reference for all purposes.

### FIELD

The present description relates generally to formulations and methods for forming low carbon light weight aggregate for incorporation into concrete.

### BACKGROUND AND SUMMARY

Concrete is responsible for 7% of global greenhouse emissions. Most of the legacy CO₂ emissions associated with concrete stem from the production of Ordinary Portland Cement (OPC). Clinker (the precursor of OPC) is created in high temperature kilns releasing CO₂ from the fossil fuels used for heat, and chemical CO₂ released from limestone. One ingredient sometimes used in concrete is Light Weight Aggregate (LWA) a substitution for standard aggregates.

LWAs play a role in the built environment due to their versatility and advantageous properties, filling niches in the construction industry for their acoustic and thermal insulation properties. Their use reduces the overall load on structures, allowing for innovative architectural designs and lowering foundation requirements. Building professionals use LWAs for a wide range of construction applications where weight reduction is desired without compromising structural integrity. Some common uses include high-rise buildings, bridge decks to reduce dead load and minimize additional support structures, roof decks to provide thermal buffering, and infrastructure projects such as tunnels, retaining walls and underground structures.

Conventionally, LWAs are made from natural materials such as clay, shale, or slate heated at high temperatures until expansion to create a porous structure which reduce density while maintaining strength. For this reason, conventional LWAs have a very high carbon footprint leading to a very high carbon footprint for a lightweight concrete which are comprised of about 70% to 80% LWAs by volume. For example, the industry average Global Warming Potential (GWP) for 21 megapascal (MPa) lightweight concrete is 492 kg CO₂ eq/m3 compared to 262 kg CO₂ eq/m3 for normal weight 21 MPa concrete.

Previously, the carbon footprint of LWAs may be reduced by forming an LWA comprising biochar and Ordinary Portland Cement as a binder. The inventors have herein recognized limitations to this approach. For example, Ordinary Portland Cement has a high GWP. Additionally, the resulting lightweight concrete may not achieve a desired density and may fall short of desired physical properties.

The inventors have recognized the above-mentioned drawbacks in the previous strategies for mitigating the carbon footprint of LWAs and developed a solution to at least partially overcome the drawbacks. For example, a low carbon LWA comprised of biochar, binder, supplementary cementitious material, fine aggregates, and water. One or more of the components of the low carbon LWA in addition to the biochar may be waste material repurposed in the low carbon LWA. Further, the low carbon LWA incorporates carbon in the form of CO₂ mineralization which may be carbon recovered from CO₂ emissions of the pyrolysis process used to form the biochar. In this way, a circular economy is formed using both the biochar and the waste emissions of pyrolysis.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an illustration of a process flow for forming a low carbon light weight concrete aggregate.

FIG. 2 shows a flowchart of an example of a method for forming the low carbon light weight aggregate and lightweight concrete using the low carbon light weight aggregate.

FIG. 3A shows a first photograph of the low carbon light weight aggregate.

FIG. 3B shows an illustration of a cross section of lightweight concrete including low carbon LWA.

FIG. 3C shows a second photograph of the low carbon light weight aggregate.

FIG. 4 shows a chart comparing strength of low carbon light weight aggregates under different curing conditions.

### DETAILED DESCRIPTION

The following description relates to formulations and methods for low carbon LWA. ASTM C330 defines the maximum dry loose bulk density of LWA for structural concrete as 1120 kg/m3 for fine aggregate (0-4.5 mm), 880 kg/m3 for coarse aggregate (4.5-12.5 mm), and 1040 kg/m3 for combined fine and coarse aggregate (0-12.5 mm). European Standard 13055 specifies LWA for concrete as having particle densities not exceeding 2000 kg/m3 (2,000 Mg/m3) or loose bulk densities not exceeding 1200 kg/m3 (1,200 Mg/m3).

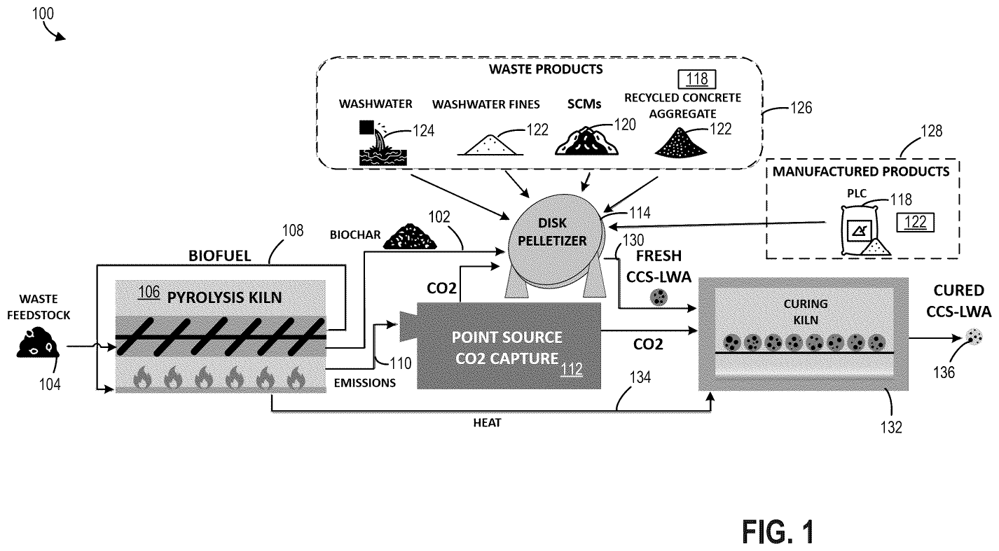

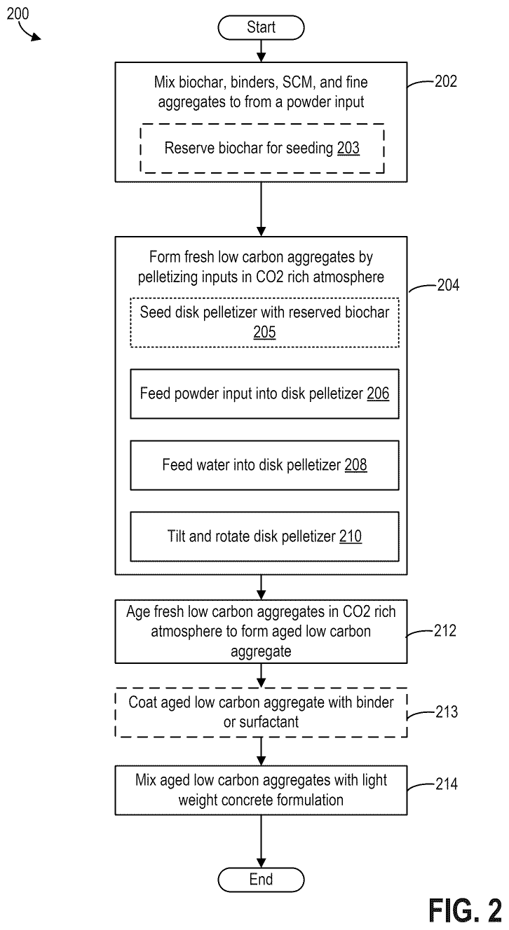

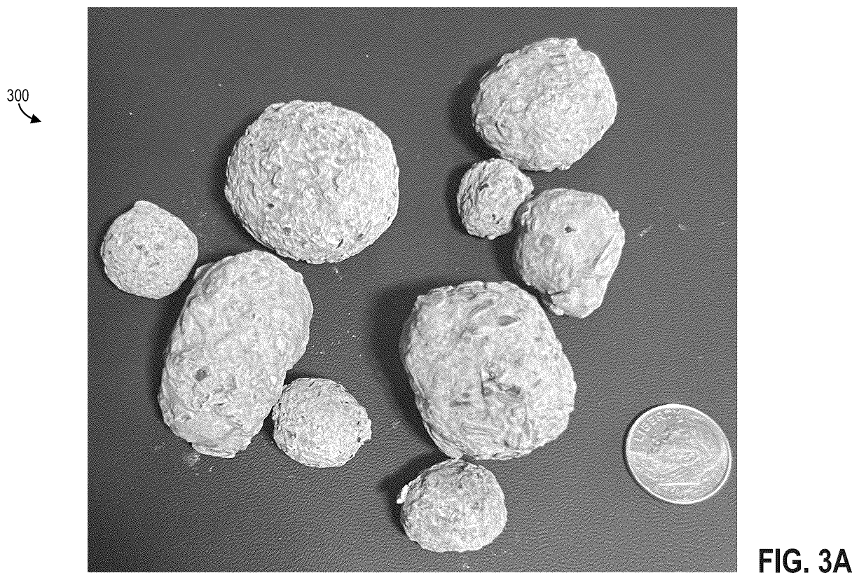

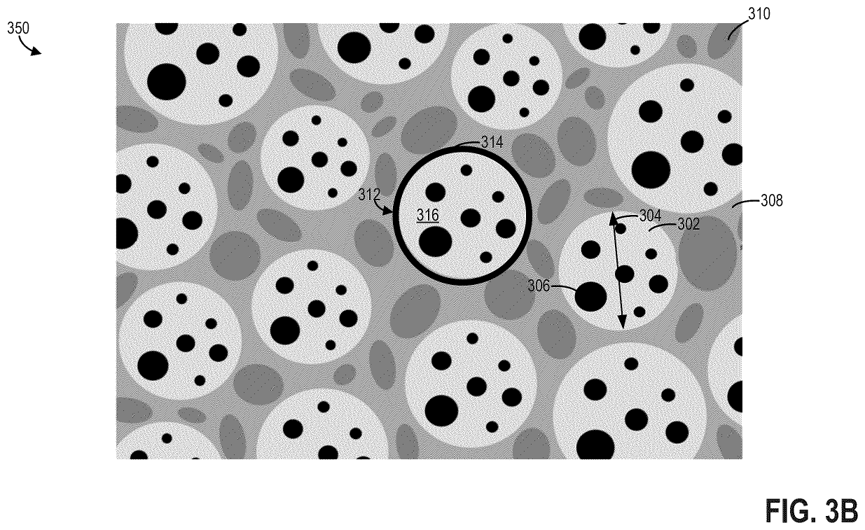

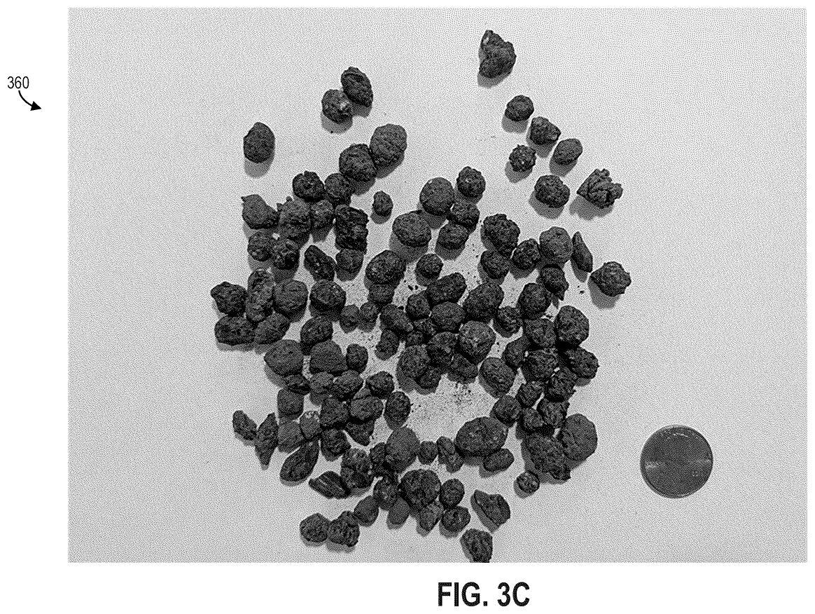

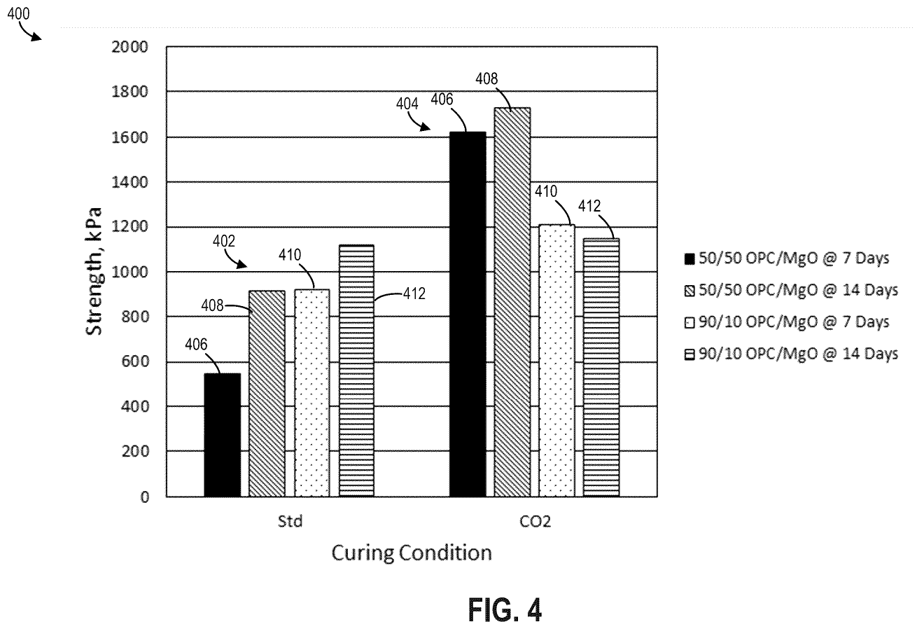

The low carbon LWA may include biochar, binders, supplementary cementitious materials, fine aggregates, and water and may be pelletized and aged in a CO₂ atmosphere as shown in the process flow illustration of FIG. 1. A chart comparing strength of the low carbon LWA during curing is shown in FIG. 4. A method for forming the low carbon LWA and incorporating into a lightweight concrete is shown in FIG. 2. A photograph of the resulting low carbon LWA is shown in FIGS. 3A and 3C and a corresponding lightweight concrete including the LWA is illustrated in FIG. 3B.

Turning now to FIG. 1, an illustration 100 depicting a process of forming a low carbon LWA is shown. The low carbon LWA may include a biochar 102. Biochar 102 may be produced by inputting a waste feedstock 104 into a pyrolysis kiln 106. Waste feedstock 104 may be a biogenic carbon source of organic origin. For example, waste feedstock 104 may include one or more of wood biomass, municipal biosolids, and/or agricultural crop waste, among others. In some examples the wood biomass may be a mixed wood biomass. Pyrolysis kiln 106 may be configured to pyrolyze (e.g., heat in a low-oxygen environment) waste feedstock 104 to produce biochar 102 and biofuel 108. In some examples, pyrolysis kiln 106 may pyrolyze waste feedstock 104 at temperatures ranging from 500° F. up to 800° F. Biofuel 108 may then be used as fuel for running pyrolysis kiln 106. Pyrolysis may also generate CO₂ emissions 110. CO₂ emissions 110 may be captured at a point source 112 by using, for example, carbon dioxide (CO₂) recovery technologies using custom regenerable amine-based capture technologies to remove pollutants from industrial off-gases. The CO₂ emissions may then be used further downstream in the production of low carbon LWA as discussed further below. Additionally, or alternatively, the point source capture may also trap biogenic particulate emissions from pyrolysis kiln 106.

The biochar 102 output by pyrolysis kiln 106 may, in some examples, be ground and sieved to a particle size range. For example, a gradation of biochar 102 may be in a range from passing a 325 mesh screen up to passing a ½″ mesh screen. Biochar 102 may include carbon in a range of 25 wt. % up to 85 wt. %. In further examples, biochar 102 may include carbon in a range of 25 wt. % up to 90 wt. %.

Biochar 102 may be input to a disk pelletizer 114 along with binders 118, supplementary cementitious material (SCM) 120, fine aggregates 122, and water 124. Using SCMs 120 in pelletizing the fresh low carbon LWA 130 may enhance material performance of the aged low carbon LWA and may also increase an amount of carbon captured by the low carbon LWA (e.g., increased carbon intensity). The additional components may include a combination of waste products 126 and/or manufactured products 128.

As one example, Portland Limestone Cement (PLC) may be a manufactured product included in binders 118. As a further example, cements used as binders 118 may be additionally or alternatively be made from industrial wastes. For example, binders 118 may include, but are not limited to, one or more of super sulfated slag, activated slag, magnesium oxide or hydroxide based cements, cement produced from electric arc furnace flux, cements produced from electrolytic reactions of non-carbonate materials, cements produced from hydrothermal reactions, cements produced from reactive calcium carbonate polymorphs such as vaterite, and purchased cement formulations. Purchased cement formulations may include, but is not limited to, one or more of Brimstone™ Portland cement, Sublime Cement®, Queens Carbon cement, and Fortera ReAct™ cement. Herein, slag refers to granulated ground blast furnace slag. When magnesium oxide is used as the binder in combination with a cement (e.g., Ordinary Portland Cement) the combination may result in an unexpected increase a CO₂ uptake of the low carbon LWA and an increase in strength of the aggregate. A ratio of OPC to MgO may be in a range of 30/70 to 50/50. For example the range of OPC to MgO may be 30/70.

FIG. 4 shows a chart 400 of strength of the low carbon LWA including a combination of OPC and MgO. A first set of bars 402 corresponds to low carbon LWA cured under standard conditions (e.g., in air) and a second set of bars 404 corresponds to low carbon LWA cured in a CO₂ atmosphere. Bars 406 correspond to a 50/50 by weight ratio of OPC to MgO in the low carbon LWA after 7 days of curing and bars 408 correspond to the same 50/50 ratio after 14 days of curing. Bars 410 correspond to a 90/10 by weight ratio of OPC to MgO after 7 days of curing. Bars 412 correspond to the same 90/10 ratio after 14 days of curing.

As shown in chart 400 a 50/50 mixture of OPC to MgO results in a larger increase in mass and a larger strength increase in the CO₂ environment than the 90/10 mixture. Without being bound by theory an increase in MgCO₃ forms from a reaction of MgO with CO₂. In this way, increasing the MgO content to the 50/50 mixture enhances strength development of the low carbon lightweight aggregate in a CO₂ rich environment. Further, the low carbon LWA materials with MgO were stronger after curing in a CO₂ environment.

SCM 120 may include one or more of fly ash, ground glass pozzolans, natural pozzolans, slag, biochar derived SCM, silica fume or fine powder crushed concrete residue. As one example, biochar derived SCM may be biochar including a carbon content of less than 50 wt. %. carbon. In alternate examples, biochar derived SCM may be biochar including a carbon content of less than 60 wt. % carbon. Fine aggregates 122 may include one or more of concrete batch plant wastewater fines and recycled concrete aggregate. Additionally, or alternatively fine aggregates 122 may include conventional fine aggregates such as sand. In some examples, fine aggregates 122 may additionally or alternatively include pumice sand. Water 124 may include recovered concrete wash water. Recovered concrete wash water 124 may be highly alkaline which may be beneficial to the primary hydration process for primary binders and the pozzolanic reaction process for SCMs. Additionally, or alternatively, water 124 may include municipal tap water.

Biochars 102, binders 118, supplementary cementitious materials (SCM) 120, fine aggregates 122, and water 124 may be included in a low carbon LWA formulation. A composition of the low carbon LWA formulation is provided in Table 1 below. Based on the weighted average of the densities of solid and liquid ingredients of the formulation, the formulation has an estimated particle density of about 1.71 g/cm3. To achieve a particle density of less than 2.0 g/cm3, a cut off for LWA density, the binder to biochar ratio(s) may be limited as well as the liquid to total solids ratio. In this way the binder to biochar ratio of the formulation and the total liquid to solids ratio may work synergistically to result in a low carbon LWA formulation with desired low density. A low density may be less than 2.0 g/cm3. For example, it may be demanded to limit the density of the biochar(s) being used to an average of approximately 2.0 g/cm3.

TABLE 1
Components of a low carbon LWA formulation

| | Parts by | Parts by | Density | Typical |
|---|---|---|---|---|
| | Mass | Mass | Range | Density |
| Formulation Constituent | Range | Example | (g/cm3) | (g/cm3) |
| Binder + SCM | 1-1.5 | 1 | 2.7-3.1 | 2.9 |
| Biochar 1 | 0.25-1 | 1 | 2.1-2.5 | 2.3 |
| Biochar 2 | 0.25-1 | 0.75 | 1.5-1.9 | 1.7 |
| Fine Aggregate | 0-1 | 0.25 | 2.5-2.7 | 2.6 |
| Total Solids | 1.5-4.5 | 3 | | |
| Water | 0.9-4.5 | 2.4 | 0.9-1.1 | 1 |
| Liquid to Total Solids Ratio | 0.6-1 | 0.8 | | |

The low carbon LWA may be pelletized under a CO₂ rich atmosphere. In some examples, the CO₂ rich atmosphere may be generated by directing CO₂ captured at point source 112 into disk pelletizer 114.

After pelletization, fresh low carbon LWA 130 may be output from disk pelletizer 114. Fresh low carbon LWA 130 may be directed to a curing kiln 132 for aging. In some examples, the fresh low carbon LWA may be aged in a CO₂ rich atmosphere (e.g., concentrated CO₂ atmosphere). The CO₂ rich atmosphere may cause enhanced carbonated curing of fresh low carbon LWA 130. Enhanced carbonated aging may cause the formation of CO₂ mineralization to help increase strength of the aged low carbon LWA 136. High strength light weight aggregates increase the strength and performance of light weight concrete made from said aggregates. In some examples, the CO₂ may be generated by CO₂ captured at point source 112. In alternate examples the CO₂ may be directed to curing kiln 132 from a gas canister of CO₂ obtained from other CO₂ sources. In some examples, waste heat 134 may be captured from pyrolysis kiln 106 and directed to curing kiln 132. In some embodiments aging of low carbon LWA may take place at temperatures ranging from 60 degrees Fahrenheit to 150 degrees Fahrenheit. Aged low carbon LWA 136 may be collected from curing kiln 132 and further used in forming lightweight concrete. For example, the aged low carbon LWA may be a density that is compliant with the ASTM C330 standard for lightweight aggregates.

Turning now to FIG. 2, a flowchart of a method 200 for forming low carbon LWA and incorporating the low carbon LWA into a lightweight concrete is shown. At 202, method 200 includes mixing biochar, SCM, binders, and fine aggregates to form a powder input. The biochar, SCM, binders, and fine aggregates may include waste materials and/or manufactured materials as described above with respect to FIG. 1. Optionally, at 203, method 200 includes reserving biochar from the powder input for seeding. The reserved portion may be kept separate from the remaining components of the powder input. The amount of biochar included in the powder input may be adjusted to account for a portion of biochar being added to the pelletizer separately from the remaining powder input components.

At 204, method 200 includes forming fresh low carbon LWA by pelletizing the inputs in a CO₂ rich atmosphere. The CO₂ rich atmosphere may include CO₂ at partial pressures in excess of those in the ambient environment. The excess CO₂ of the CO₂ rich atmosphere may be provided by CO₂ collected from emissions of a pyrolysis kin as described above with respect to FIG. 1.

Forming the fresh low carbon LWA by pelletizing includes, at 206, feeding the powder input into a disk pelletizer, such as disk pelletizer 114 of FIG. 1. The disk pelletizer may have a pan diameter in a range of 20″ up to 320″. The powder input may be fed into the disk pelletizer via a vibratory feeding mechanism. Optionally, at 205, method 200 includes seeding the pelletizer with the reserved biochar before feeding the powder input into the disk pelletizer. Seeding the disk pelletizer may include manually feeding the disk pelletizer with the reserved biochar to seed pellet formation before feeding the remainder of the powder input via a vibratory feeding mechanism. Seeding may include adding dry material (e.g., biochar) to the pan before water is introduced. The dry material in the pan may promote balling up of the low carbon LWA and may be referred to as LWA seed. The LWA seed may be in the pan for the initial spray of water to hid and may immediately pelletize. Without the LWA seed the powder input being fed at the same time as the water may not pelletize as quickly and may be more crumbly and less strong than when seeded. At the same time as feeding the powder input, at 208, step 204 includes feeding water into the disk pelletizer. Feeding water may include feeding through a pressurized spray nozzle system. The water may include recovered concrete wash water and/or tap water as described above with respect to FIG. 1. Further, pelletizing at step 204 includes tilting and rotating the disk pelletizer at 210. In some examples, tilting the disk pelletizer may include tilting at an angle in a range of 30° up to 80°. In an alternate example, the angle may be in a range of 5° up to 45°. Rotating the disk pelletizer may include rotating at a rate in a range of 2 rpm up to 65 rpm. For example, forming fresh low carbon LWA may include pelletizing in a 20″ pan, with tap water at a pan tilt of 55° rotating at 45 rpm.

At 212, method 200 includes aging the fresh low carbon LWA in a CO₂ rich atmosphere to form cured low carbon LWA. The CO₂ rich atmosphere may at least partially be provided by CO₂ gas output by the pyrolysis process as described above with respect to FIG. 1.

Optionally, at 213, method 200 includes coating the aged low carbon LWA with a binder or surfactant. Coating may include at least partially covering an outer surface area of a particulate of low carbon LWA with a binder. Coating the aged low carbon LWA with binder may include forming a layer of pure binder material around the outer surface of the low carbon LWA. The additional binder material forming the coating may create a hard outer shell surround the low carbon LWA before incorporating the low carbon LWA into a concrete formulation. The coating of binder may increase strength of the low carbon LWA and strength of the low carbon LWA-concrete interface, thus improving performance of the concrete.

Alternatively, coating may include covering an outer surface of the aged low carbon LWA with a sacrificial surfactant. Coating with the sacrificial surfactant may include soaking the aged low carbon LWA in a solution containing a surfactant. The surfactant may include, but is not limited to, sodium dodecyl sulfonate (SDS), cocamide diethanolamine (CDEA), and Triton™ X-100. The sacrificial surfactant of the coating may decrease a demand for air entrainers that is conventionally observed for concrete containing biochar.

At 214, method 200 includes mixing the aged low carbon LWA in a light weight concrete formulation. As one example, the low carbon LWA may be a one-to-one substitute for conventional lightweight aggregates. In other examples the conventional lightweight aggregate may only be partially replaced for low carbon LWA. For example, 50% of the conventional lightweight aggregate may be replaced with low carbon LWA. As a further example, the concrete may include 70/30 with 100% LWA of coarse and low dose replacement for conventional aggregate. Method 200 ends.

Turning now to FIG. 3A, a photograph 300 of low carbon LWA is shown, in the formed and aged state, such as after step 212 of method 200. Shapes of the low carbon LWA may vary from substantially spherical to more oblong (e.g., elliptical). In some examples, a diameter of the low carbon LWA may be in a range of 1.18 millimeters (No. 16) up to 90 millimeters (3.5″). An additional photograph 350 of the low carbon LWA is shown in FIG. 3C.

Turning now to FIG. 3B, an illustration 350 of a cross section of a concrete including low carbon LWA 302 is shown. The low carbon LWA may be formed using the process diagramed in FIG. 1 and the method described in FIG. 2 above. The low carbon LWA 302 may be roughly spherically shaped. A diameter 304 may depend on a type of concrete the low carbon LWA is incorporated into. In one example, the of low carbon LWA 302 may be in a range of 0.15″ up to 1.5″. In an alternate example, the diameter may be in a range of 1.18 millimeters (No. 16) up to 90 millimeters (3.5″). One or more of the low carbon LWA may be a coated low carbon LWA 312. Coated low carbon LWA 312 may include a coating 314 in face sharing contact with an outer surface with a low carbon LWA core 316. The coating 314 may be formed of additional binder and/or sacrificial surfactant deposited after aging the low carbon LWA as discussed above with respect to FIG. 2. Low carbon LWA 302 and coated low carbon LWA 312 may each be embedded in the cement paste 308 and aggregates 310 comprising the remainder of the concrete formulation. Each low carbon LWA may include a plurality of biochar particles 306 and may show signs of CO₂ mineralization. The CO₂ mineralization may be formed during aging of the low carbon LWA in a CO₂ rich atmosphere as described above.

The technical effect of method 200 is to form a low carbon LWA that is at least carbon negative (e.g., GWP <0) while also resulting in a density that passes typical standards for lightweight aggregates. By incorporating multiple waste products into the low carbon LWA formulation, both the GWP of the low carbon LWA and an overall environmental impact of the manufacturing process may be decreased. Additionally, by directing CO₂ emitted by the waste pyrolysis into the low carbon LWA as CO₂ mineralization a strength of the low carbon LWA may be increased while also further reducing the GWP of the low carbon LWA.

The disclosure also provides support for a low carbon LWA, comprising: biochar, binder, supplementary cementitious material (SCM), fine aggregates, and water. In a first example of the system, the low carbon LWA includes CO2 mineralization. In a second example of the system, optionally including the first example, the binder is one or more of Ordinary Portland Cement (OPC), Portland Limestone Cement (PLC), super sulfated slag, activated slag, magnesium oxide or hydroxide based cements, cement produced from electric arc furnace flux, cements produced from electrolytic reactions of non-carbonate materials, cements produced from hydrothermal reactions, and cements produced from reactive calcium carbonate polymorphs. In a third example of the system, optionally including one or both of the first and second examples, the SCM is one or more of fly ash, ground glass pozzolans, natural pozzolans, slag, biochar derived SCM, silica fume, and fine powder crushed concrete residue. In a fourth example of the system, optionally including one or more or each of the first through third examples, the SCM is biochar derived SCM comprised of less than 60 wt. % carbon. In a fifth example of the system, optionally including one or more or each of the first through fourth examples, the biochar is comprised of 25 wt. % up to 90 wt. % carbon. In a sixth example of the system, optionally including one or more or each of the first through fifth examples, the fine aggregates are one or more of concrete batch plant wastewater fines, recycled concrete aggregate, and pumice sand, and LWA seed. In a seventh example of the system, optionally including one or more or each of the first through sixth examples, a density of the low carbon LWA is ASTM C330 compliant for lightweight aggregates. In an eighth example of the system, optionally including one or more or each of the first through seventh examples comprising 1.75 parts by mass biochar, 1 part by mass biochar and SCM, 0.25 parts by mass fine aggregates and 2.4 parts by mass water.

The disclosure also provides support for a method for forming low carbon LWA, comprising: feeding a powder input comprising biochar, binder, supplementary cementitious material (SCM), and fine aggregates into a disk pelletizer, feeding water into the disk pelletizer, and tilting and rotating the disk pelletizer to form fresh low carbon LWA. In a first example of the method, the method further comprises: reserving biochar from the powder input and seeding the disk pelletizer with the reserved biochar before feeding the powder input. In a second example of the method, optionally including the first example, the method further comprises: aging the fresh low carbon LWA in a CO2 rich atmosphere to form aged low carbon LWA. In a third example of the method, optionally including one or both of the first and second examples, heat for aging the fresh low carbon LWA is waste heat from pyrolysis of waste feedstock to form the biochar. In a fourth example of the method, optionally including one or more or each of the first through third examples, the method further comprises: coating the aged low carbon LWA with a coating formed of additional binder or surfactant. In a fifth example of the method, optionally including one or more or each of the first through fourth examples, rotating the disk pelletizer includes rotating at a rate in a range of 2 to 65 rpm. In a sixth example of the method, optionally including one or more or each of the first through fifth examples, feeding water includes feeding water through a pressurized spray nozzle system, wherein the water includes concrete wash water. In a seventh example of the method, optionally including one or more or each of the first through sixth examples, forming fresh low carbon LWA includes forming fresh low carbon LWA in a CO2 rich atmosphere.

The disclosure also provides support for a concrete, comprising: low carbon LWA, wherein the low carbon LWA includes biochar, binder, supplementary cementitious material, and fine aggregates. In a first example of the system, the concrete comprising the low carbon LWA is a light weight concrete. In a second example of the system, optionally including the first example, a diameter of the low carbon LWA is in a range of 1.18 millimeters (No. 16) up to 90 millimeters (3.5″).

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A low carbon LWA, comprising:
biochar;
binder;
supplementary cementitious material (SCM);
fine aggregates; and
water.

2. The low carbon LWA of claim 1, wherein the low carbon LWA includes CO₂ mineralization.

3. The low carbon LWA of claim 1, wherein the binder is one or more of Ordinary Portland Cement (OPC), Portland Limestone Cement (PLC), super sulfated slag, activated slag, magnesium oxide or hydroxide based cements, cement produced from electric arc furnace flux, cements produced from electrolytic reactions of non-carbonate materials, cements produced from hydrothermal reactions, and cements produced from reactive calcium carbonate polymorphs.

4. The low carbon LWA of claim 1, wherein the SCM is one or more of fly ash, ground glass pozzolans, natural pozzolans, slag, biochar derived SCM, silica fume, and fine powder crushed concrete residue.

5. The low carbon LWA of claim 1, wherein the SCM is biochar derived SCM comprised of less than 60 wt. % carbon.

6. The low carbon LWA of claim 1, wherein the biochar is comprised of 25 wt. % up to 90 wt. % carbon.

7. The low carbon LWA of claim 1, wherein the fine aggregates are one or more of concrete batch plant wastewater fines, recycled concrete aggregate, and pumice sand, and LWA seed.

8. The low carbon LWA of claim 1, wherein a density of the low carbon LWA is ASTM C330 compliant for lightweight aggregates.

9. The low carbon LWA of claim 1, comprising 1.75 parts by mass biochar, 1 part by mass biochar and SCM, 0.25 parts by mass fine aggregates and 2.4 parts by mass water.

10. A method for forming low carbon LWA, comprising:
feeding a powder input comprising biochar, binder, supplementary cementitious material (SCM), and fine aggregates into a disk pelletizer;
feeding water into the disk pelletizer; and
tilting and rotating the disk pelletizer to form fresh low carbon LWA.

11. The method of claim 10, further comprising reserving biochar from the powder input and seeding the disk pelletizer with the reserved biochar before feeding the powder input.

12. The method of claim 10, further comprising aging the fresh low carbon LWA in a CO₂ rich atmosphere to form aged low carbon LWA.

13. The method of claim 12, wherein heat for aging the fresh low carbon LWA is waste heat from pyrolysis of waste feedstock to form the biochar.

14. The method of claim 13, further comprising coating the aged low carbon LWA with a coating formed of additional binder or surfactant.

15. The method of claim 10, wherein rotating the disk pelletizer includes rotating at a rate in a range of 2 to 65 rpm.

16. The method of claim 10, wherein feeding water includes feeding water through a pressurized spray nozzle system, wherein the water includes concrete wash water.

17. The method of claim 10, wherein forming fresh low carbon LWA includes forming fresh low carbon LWA in a CO₂ rich atmosphere.

18. A concrete, comprising:
low carbon LWA, wherein the low carbon LWA includes biochar, binder,
supplementary cementitious material, and fine aggregates.

19. The concrete of claim 18, wherein the concrete comprising the low carbon LWA is a light weight concrete.

20. The concrete of claim 18, wherein a diameter of the low carbon LWA is in a range of 1.18 millimeters (No. 16) up to 90 millimeters (3.5″).
